(19) United States
(12) Patent Application Publication
(10) Pub. No.: US 2009/0141196 A1
(43) Pub. Date: Jun. 4, 2009

(54) Photo microprojector

(76) Inventors: Charles M. Basner, Lebanon, NJ (US); Kenneth P. Glynn, Flemington, NJ (US)

Correspondence Address: Charles M. Basner, 29 Country Oaks Road, Lebanon, NJ, 08833, US

(21) Appl. No.: 11/999,172

(22) Filed: Dec. 3, 2007

(51) Int. Cl. H04N 5/64

(52) U.S. Cl. 348/789; 348/E05.128

(57) ABSTRACT

A photo microprojector for projecting digital photo albums, includes: a.) a main housing having a lens port; b.) a digital photo input means within the housing and including at least one input port; c.) a microprocessor in the main housing includes: i) digital photo storage means for storing inputted digital photos; ii) digital photo organization means for selecting and arranging digital photos stored in the microprocessor; iii) a controller for managing a digital photo album presentation that includes a start function, a stop function, and a pause function the microprocessor being connected to the digital photo input means; d.) a lens located in the lens port; e.) a display screen located in the main housing and behind the lens and connected to the microprocessor, the display screen being adapted to receive photo images from the microprocessor; f.) a light source located behind the display screen to project photo images from the display screen and magnified through the lens for projection, the light source being connected to the microprocessor; g.) a lens port swivel mount is moveably connected to the main housing so as to have a front position; and, h.) a power source connected to the microprocessor.

### BACKGROUND OF INVENTION

a. Field of Invention

The invention relates generally to microprojectors for receiving, storing and projecting digital photo albums in a manner that allows a proud user to carry the device like a photo locket or otherwise on his or here person.

b. Description of Related Art

The following patents are representative of a log in system:

United States Patent Application Publication No. 2004/0070563 A1 to Wearable Imaging Device describes an imaging device is disclosed that is portable and is adapted to be worn on or about the body of a user. The imaging device includes a light source that emits a beam of light and a scanning optical assembly for steering the light beam biaxially onto an external surface thereby generating an image. In one embodiment, the light beam is a laser. The image can be viewed on a variety of surfaces, e.g., a user's hand or tabletop. An interaction means can be included for interaction between the user and the projected image. The imaging device can communicate with external computing devices, such as, devices connected via a personal area network. The imaging device does not require the user to focus the image when projecting it onto surfaces having different distances. Power consumption of the imaging device is minimized.

United States Patent Application Publication No. 2002/0024512 A1 to Terasawa et al. describes a computer system comprises a computer body that is attachable to a user's body. A projection port is formed in the outer surface of a housing of the computer body. The housing contains therein a display element that projects an image outward from the housing through the projection port. The housing further contains therein a vibration detecting element for detecting vibration of the computer body, a discriminating element for determining whether or not the computer body is moving, in accordance with a vibration pattern detected by means of the vibration detecting element, and a main control element adapted to stop the image display by means of the display element when it is concluded by the discriminating element that the computer body is moving.

U.S. Pat. No. 7,210,806 B2 to Holman et al. describes a compact and efficient optical illumination system featuring planar multi-layered LED light source arrays concentrating their polarized or un-polarized output within a limited angular range. The optical system manipulates light emitted by a planar array of electrically-interconnected LED chips positioned within the input apertures of a corresponding array of shaped metallic reflecting bins using at lease one of elevated prismatic films, polarization converting films, micro-lens array and external hemispherical or ellipsoidal reflecting elements. Practical applications of the LED array illumination systems include compact LCD or DMD video image projectors, as well as general lighting automotive lighting and LCD backlighting.

U.S. Pat. No. 6,830,344 B2 to Akeseli Reho et al. describes the invention relates to a wearable display means of projector type and to a garment. The invention relates specifically to a miniature projector, which is worn by the user and whose application is compatible with wearable electronic data processing systems. One concept of the invention is to project the electronic information generated by wearable electronic devices connected to the projector in the user's field of vision by means of the projector. The projector of the invention is equipped with a matrix consisting of at least one Resonance Cavity LED or a micro-mirror and with electronics and optics necessary for projecting. The projector and the electronic devices are integrated in the garment of the invention.

U.S. Pat. No. 6,655,597 B1 to Jerome Swartz et al. describes a portable instrument incorporates an electro-optical assembly for reading indicia during a reading mode, and for projecting a bit-mapped color image during a display mode. A manually operable switch on the instrument is disposed for selecting one of the modes. The color image is formed by pulsing a plurality of differently colored lasers at selected times on selected scan lines.

U.S. Pat. No. 6,371,616 B1 to Fuad Elias Doany et al. describes miniature devices which incorporate data displaying features incorporating an information processing and display system, which includes devices for the representation of textural and pictorial information and data, and which is adapted to project images onto a remote display surface. Also disclosed is a method for utilizing miniature information processing devices which incorporate projectors for projecting data onto remote surfaces.

U.S. Pat. No. 6,312,129 B1 to Ashok Sisodia et al. describes a head mounted projection unit and system disclosed. The unit includes a tapered optical relay that allows the use of a simple optical projection system. The unit further includes structure for allowing the transmission of images having both low resolution portions and high resolution portions.

U.S. Pat. No. 6,057,966 to David W. Carroll et al. describes a body-mountable display device includes an image source for producing an image, and image transmission device including at least one optically-transmissive fiber, the image transmission device being mountable on the body of a user, projection optics for receiving and relaying the image carried by the image transmission device, and a display for receiving the image from the image transmission device and projecting the image to at least one person. Embodiments of the invention are of significantly reduced size and weight, significantly reduced power consumption and thermal output, and significantly increased durability and reliability. Embodiments of the invention also are more aesthetically pleasing in appearance. Corresponding method embodiments provide similar advantages.

Notwithstanding the prior art, the present invention is neither taught nor rendered obvious thereby.

### SUMMARY OF INVENTION

The present invention provides a photo microprojector for projecting digital photo albums, and that may be worn by a human, e.g., on a chain or necklace, sting or rope, clip or other human or garment attachment, for easy access and presentation to the wearer or other person(s). In essence, it preferably functions like a locket or other miniature photo holder, but stores and presents an entire album of digital photos by small footprint projection (hence the term “microprojector”).

In some preferred embodiments, the present invention photo microprojector for projecting digital photo albums, includes: a.) a main housing adapted to be worn on a human, the main housing having a lens port; b.) a digital photo input means within the main housing and including at least one input port; c.) a microprocessor in the main housing that includes: i) digital photo storage means for storing a plurality of inputted digital photos; ii) digital photo organization means for selecting and arranging digital photos stored in the microprocessor; iii) a controller for managing a digital photo album presentation that includes a start function, a stop function, and a pause function the microprocessor being connected to the digital photo input means; d.) a lens located in the lens port; e.) a display screen located in the main housing and behind the lens and connected to the microprocessor, the display screen being adapted to receive photo images from the microprocessor; f.) a light source located behind the display screen so as to project photo images from the display screen and magnified through the lens for projection therefrom, the light source being connected to the microprocessor; g.) a lens port swivel mount located at the lens port and being moveably connected to the main housing so as to have a front position; and, h.) a power source connected to the microprocessor.

In some preferred embodiments of the present invention photo microprojector for projecting digital photo albums as described in the previous paragraph, the lens port swivel mount is a hinged mount having at least one axis of rotation. In other preferred embodiments, the lens port swivel mount is a universal joint swivel mount. In others, the lens port swivel mount is a bellows mount having popoid features. In yet others, the lens port swivel mount is a gooseneck swivel mount.

In some preferred embodiments of the present invention photo microprojector for projecting digital photo albums, the light source is an LED.

In some preferred embodiments of the present invention photo microprojector for projecting digital photo albums, the display screen is an LCD.

In some preferred embodiments of the present invention photo microprojector for projecting digital photo albums, the light source is an LED and the display screen is an LCD.

In some preferred embodiments of the present invention photo microprojector for projecting digital photo albums, the power source is a battery source, either disposable or rechargeable. In other embodiments, any available power source may be used, e.g., solar cell, fuel cell or the like.

In some preferred embodiments of the present invention photo microprojector for projecting digital photo albums, the controller further includes at least one additional function selected from the group consisting of: a reverse function, adapted to reverse at least a portion of a digital photo album presentation; a select function, adapted to permit a user to choose specific digital photos from a stored digital photo album for presentation, reorganization, or deletion; a delete feature that is adapted to enable a user to delete one or more digital photos.

In some preferred embodiments of the present invention photo microprojector for projecting digital photo albums, the controller further includes an auto cycle function adapted to sequentially present digital photos for a predetermined time in a predetermined sequence.

In some preferred embodiments of the present invention photo microprojector for projecting digital photo albums, the microprojector further includes a stand component. The stand component may be selected from the group consisting of a flat horizontal surface, a hinged pullout bracket, and a telescopic pullout stand.

In another version of the present invention, the photo microprojector for projecting a digital photo album includes: a.) a main housing adapter to be worn on a human, the main housing having a lens port; b.) a digital photo input means within the main housing and including at least one input port; c.) a microprocessor in the main housing that includes: (i) digital photo storage means for storing a plurality of inputted digital photos; (ii) digital photo organization means for selecting and arranging digital photos stored in the microprocessor; (iii) a controller for managing a digital photo album presentation that includes a start function, a stop function, and a pause function the microprocessor being connected to the digital photo input means; d.) an articulated projection housing component in the lens port; e.) a lens located in the articulated projection housing component; f.) a display screen located in the articulated projection housing component and behind the lens and connected to the microprocessor, the display screen being adapted to receive photo images from the microprocessor; g.) a light source located behind the display screen so as to project photo images from the display screen and magnified through the lens for projection therefrom, the light source being connected to the microprocessor; and, h.) a power source connected to the microprocessor; wherein the articulated projection housing component is adapted for slideable movement at least partially out of and into the main housing and is further adapted for at least partial swivel movement away from a perpendicular axis relative to the main housing.

In some preferred embodiments of the present invention photo microprojector for projecting digital photo albums as described in the previous paragraph, the articulated projection housing component has a swivel mount that is a hinged mount having at least one axis of rotation. In other preferred embodiments, the swivel mount is a universal joint swivel mount. In others, the swivel mount is a bellows mount having popoid features. In yet others, the swivel mount is a gooseneck swivel mount.

In some preferred embodiments of the present invention photo microprojector for projecting digital photo albums, the light source is an LED.

In some preferred embodiments of the present invention photo microprojector for projecting digital photo albums, the display screen is an LCD.

In some preferred embodiments of the present invention photo microprojector for projecting digital photo albums, the light source is an LED and the display screen is an LCD.

In some preferred embodiments of the present invention photo microprojector for projecting digital photo albums, the power source is a battery source, either disposable or rechargeable. In other embodiments, any available power source may be used, e.g., solar cell, fuel cell or the like.

In some preferred embodiments of the present invention photo microprojector for projecting digital photo albums, the controller further includes at least one additional function selected from the group consisting of: a reverse function, adapted to reverse at least a portion of a digital photo album presentation; a select function, adapted to permit a user to choose specific digital photos from a stored digital photo album for presentation, reorganization, or deletion; a delete feature that is adapted to enable a user to delete one or more digital photos.

In some preferred embodiments of the present invention photo microprojector for projecting digital photo albums, the controller further includes an auto cycle function adapted to sequentially present digital photos for a predetermined time in a predetermined sequence.

In some preferred embodiments of the present invention photo microprojector for projecting digital photo albums, the microprojector further includes a stand component. The stand component may be selected from the group consisting of a flat horizontal surface, a hinged pullout bracket, and a telescopic pullout stand.

In a third version of the present invention, the photo microprojector for projecting a digital photo album includes: a.) a main housing adapter to be worn on a human, the main housing barring a port; b.) a digital photo input means within the main housing and including at least one input port; c.) a microprocessor in the main housing that includes: (i) digital photo storage means for storing a plurality of inputted digital photos; (ii) digital photo organization means for selecting and arranging digital photos stored in the microprocessor; (iii) a controller for managing a digital photo album presentation that includes a start function, a stop function, and a pause function the microprocessor being connected to the digital photo input means; d.) an articulated projection housing component in the lens port; e.) a digital photo album projection module located in the articulated projection housing component, the module including a laser light source and a scanner, the laser light source and the scanner being functionally connected to the microprocessor, wherein the microprocessor includes capability to control the laser and scanning optical assembly to generate projected photo images from a stored digital photo album, the scanner including a scanning optical assembly, a raster control and a modulator, the scanner having sufficient capability to control vertical and horizontal movement of a laser beam of light generated by the laser light source so as to modulate the light beam to create a plurality of lighter and darker pixels within a raster pattern to create the projection; and, f.) a power source connected to the microprocessor; wherein the articulated projection housing component is adapted for slideable movement at least partially out of and into the main housing and is further adapted for at least partial swivel movement away from a perpendicular axis relative to the main housing.

In some preferred embodiments of the present invention photo microprojector for projecting digital photo albums, the scanner includes a scanner optical assembly having a laser beam reflector selected from the group consisting of two moveable mirrors, one moveable horizontally and the other vertically; a single mirror having both vertical and horizontal rotational axes; a rotating drum with mirrored facets; and a vibrating micro-electro-mechanical system.

In some preferred embodiments of the present invention photo microprojector for projecting digital photo albums, the articulated projection housing component has a swivel mount that is a hinged mount having at least one axis of rotation. In other preferred embodiments, the swivel mount is a universal joint swivel mount. In others, the swivel mount is a bellows mount having popoid features. In yet others, the swivel mount is a gooseneck swivel mount.

In some preferred embodiments of the present invention photo microprojector for projecting digital photo albums, the power source is a battery source, either disposable or rechargeable. In other embodiments, any available power source may be used, e.g., solar cell, fuel cell or the like.

In some preferred embodiments of the present invention photo microprojector for projecting digital photo albums, the controller further includes at least one additional function selected from the group consisting of: a reverse function, adapted to reverse at least a portion of a digital photo album presentation; a select function, adapted to permit a user to choose specific digital photos from a stored digital photo album for presentation, reorganization, or deletion; a delete feature that is adapted to enable a user to delete one or more digital photos.

In some preferred embodiments of the present invention photo microprojector for projecting digital photo albums, the controller further includes an auto cycle function adapted to sequentially present digital photos for a predetermined time in a predetermined sequence.

In some preferred embodiments of the present invention photo microprojector for projecting digital photo albums, the controller further includes an auto cycle function adapted to sequentially present digital photos for a predetermined time in a predetermined sequence.

In some preferred embodiments of the present invention photo microprojector for projecting digital photo albums, the microprojector further includes a stand component. The stand component may be selected from the group consisting of a flat horizontal surface, a hinged pullout bracket, and a telescopic pullout stand.

In a fourth version of the present invention, the photo microprojector for projecting a digital photo album, which includes: a.) a main housing adapter to be worn on a human, the main housing barring a port; b.) a digital photo input means within the main housing and including at least one input port; c.) a microprocessor in the main housing that includes:

(i) digital photo storage means for storing a plurality of inputted digital photos; (ii) digital photo organization means for selecting and arranging digital photos stored in the microprocessor; (iii) a controller for managing a digital photo album presentation that includes a start function, a stop function, and a pause function the microprocessor being connected to the digital photo input means; d.) an articulated projection housing component in the lens port; e.) a digital photo album projection module located in the articulated projection housing component, the module including an image generator with a light source, and a plurality of optical fibers, the image generator being functionally connected to the microprocessor, wherein the microprocessor includes capability to control the image generator to generate projected photo images from a stored digital photo album through the plurality of optical fibers; and, f.) a power source connected to the microprocessor; wherein the articulated projection housing component is adapted for slideable movement at least partially out of and into the main housing and is further adapted for at least partial swivel movement away from a perpendicular axis relative to the main housing.

In some preferred embodiments of the present invention photo microprojector for projecting digital photo albums, the articulated projection housing component has a swivel mount that is a hinged mount having at least one axis of rotation. In other preferred embodiments, the swivel mount is a universal joint swivel mount. In others, the swivel mount is a bellows mount having popoid features. In yet others, the swivel mount is a gooseneck swivel mount.

In some preferred embodiments of the present invention photo microprojector for projecting digital photo albums, the power source is a battery source, either disposable or rechargeable. In other embodiments, any available power source may be used, e.g., solar cell, fuel cell or the like.

In some preferred embodiments of the present invention photo microprojector for projecting digital photo albums, the controller further includes at least one additional function selected from the group consisting of: a reverse function, adapted to reverse at least a portion of a digital photo album presentation; a select function, adapted to permit a user to choose specific digital photos from a stored digital photo album for presentation, reorganization, or deletion; a delete feature that is adapted to enable a user to delete one or more digital photos.

In some preferred embodiments of the present invention photo microprojector for projecting digital photo albums, the controller further includes an auto cycle function adapted to sequentially present digital photos for a predetermined time in a predetermined sequence.

In some preferred embodiments of the present invention photo microprojector for projecting digital photo albums, the controller further includes an auto cycle function adapted to sequentially present digital photos for a predetermined time in a predetermined sequence.

In some preferred embodiments of the present invention photo microprojector for projecting digital photo albums, the microprojector further includes a stand component. The stand component may be selected from the group consisting of a flat horizontal surface, a hinged pullout bracket, and a telescopic pullout stand.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a front view of an embodiment of a photo microprojector according to the present invention, illustrating an articulated projection housing component slideably movable from a side;

FIG. 2 is a front view of another embodiment of a photo microprojector according to the present invention, illustrating an articulated projection housing component slideably moveable from the front;

FIG. 3 is a schematic view of a photo microprojector of the present invention, illustrating a light source for projecting photo album images;

FIG. 4 is a side view of another embodiment of an articulated housing component of the present invention, illustrating a universal joint swivel mount;

FIG. 5 is a side view of another embodiment of an articulated housing component of the present invention, illustrating a bellows mount having popoid features;

FIG. 6 is a side view of another embodiment of an articulated housing component of the present invention, illustrating a gooseneck swivel mount;

FIG. 7 is a schematic view of a photo microprojector of the present invention, illustrating a laser system for projecting photo album images;

FIG. 8 is a front view of another embodiment of a laser beam reflector for the present invention photo microprojector shown in FIG. 7, illustration two moveable mirrors;

FIG. 9 is a front another embodiment of a laser beam reflector for the present invention photo microprojector shown in FIG. 7, illustrating a rotating drum with mirrored facets;

FIG. 10 is a schematic view of a photo microprojector of the present invention, illustrating a fiber optics system for projecting photo album images;

FIG. 11 is a bottom view of a stand component of the present invention, illustrating a flat horizontal surface stand;

FIG. 12 is a bottom view of a stand component of the present invention, illustrating a hinged pullout bracket stand;

FIG. 13 is a bottom view of a stand component of the present invention, illustrating a telescopic pullout stand; and

FIG. 14 is a front view of a photo microprojector as shown in a necklace.

### DETAILED DESCRIPTION OF THE EMBODIMENTS

The present invention relates to a photo microprojector for receiving, storing and projecting digital photo albums in a manner that allows a proud user to carry the device on his or her person. More specifically, the photo microprojector may be worn by a humans e.g., on a chain or necklace, sting or rope, clip or other human or garment attachment, for easy access and presentation to the wearer or other person(s). In essence, it preferably functions like a locket or other miniature photo holder, but stores and presents an entire album of digital photos by small footprint projection (hence the term “microprojector”).

In a first preferred embodiment, the present invention photo microprojector for projecting digital photo albums includes: a.) a main housing adapted to be worn on a human, the main housing having a lens port; b.) a digital photo input means within the main housing and including at least one input port; c.) a microprocessor in the main housing that includes: i) digital photo storage means for storing a plurality of inputted digital photos; ii) digital photo organization means for selecting and arranging digital photos stored in the microprocessor; iii) a controller for managing a digital photo album presentation that includes a start function, a stop function, and a pause function the microprocessor being connected to the digital photo input means; d.) a lens located in the lens port; e.) a display screen located in the main housing and behind the lens and connected to the microprocessor, the display screen being adapted to receive photo images from the microprocessor; f.) a light source located behind the display screen so as to project photo images from the display screen and magnified through the lens for projection therefrom, the light source being connected to the microprocessor; g.) a lens port swivel mount located at the lens port and being moveably connected to the main housing so as to have a front position; and, h.) a power source connected to the microprocessor.

All of the lens port swivel movement mounts of the articulated projection housing component of the present invention at least rotate or are bellowed to allow for bending. Thus, the projected photo images are improved by facilitating placement of the image. In some preferred embodiments of the present invention photo microprojector for projecting digital photo albums, the articulated projection housing component has a swivel mount that is a hinged mount having at least one axis of rotation. In other preferred embodiments, the swivel mount is a universal joint swivel mount. In others, the swivel mount is a bellows mount having popoid features. In yet others, the swivel mount is a gooseneck swivel mount. Furthermore, the lens port swivel mounts are adapted for slideable movement at least partially out of and into the main housing.

The projection of the digital photo albums is accomplished by an LCD display screen system having a light source, by a laser scanning system or by a fiber optics system. In all the projection systems, there is a microprocessor, which controls and communicates with digital photo input and the projection system.

In some preferred embodiments of the present invention photo microprojector for projecting digital photo albums, the light source is an LED and the display screen is an LCD. The power source may be a battery source, either disposable or rechargeable, or any available power source may be used, e.g., solar cell, fuel cell or the like.

In some embodiments, the controller further includes at least one additional function selected from the group consisting of: a reverse function, adapted to reverse at least a portion of a digital photo album presentation; a select function, adapted to permit a user to choose specific digital photos from a stored digital photo album for presentation, reorganization, deletion; a delete feature that is adapted to enable a user to delete one or more digital photos, or an auto cycle function adapted to sequentially present digital photos for a predetermined time in a predetermined sequence.

In some preferred embodiments of the present invention photo microprojector for projecting digital photo albums, the photo microprojector further includes a stand component. The stand component may be selected from the group consisting of a flat horizontal surface, a hinged pullout bracket, and a telescopic pullout stand.

In a second version of the present invention, the photo microprojector for projecting a digital photo album includes: a.) a main housing adapted to be worn on a human, the main housing having a lens port; b.) a digital photo input means within the main housing and including at least one input port; c.) a microprocessor in the main housing that includes: (i) digital photo storage means for storing a plurality of inputted digital photos; (ii) digital photo organization means for selecting and arranging digital photos stored in the microprocessor; (iii) a controller for managing a digital photo album presentation that includes a start function, a stop function, and a pause function the microprocessor being connected to the digital photo input means; d.) an articulated projection housing component in the lens port; e.) a lens located in the articulated projection housing component; f.) a display screen located in the articulated projection housing component and behind the lens and connected to the microprocessor, the display screen being adapted to receive photo images from the microprocessor; g.) a light source located behind the display screen so as to project photo images from the display screen and magnified through the lens for projection therefrom, the light source being connected to the microprocessor; and, h.) a power source connected to the microprocessor; wherein the articulated projection housing component is adapted for slideable movement at least partially out of and into the main housing and is further adapted for at least partial swivel movement away from a perpendicular axis relative to the main housing.

In a third version of the present invention, the digital photo album projection module located in the articulated projection housing component module includes a laser light source and a scanner, the laser light source and the scanner being functionally connected to the microprocessor. The microprocessor includes capability to control the laser and scanning optical assembly to generate projected photo images from a stored digital photo album, the scanner including a scanning optical assembly, a raster control and a modulator. The scanner has sufficient capability to control vertical and horizontal movement of a laser beam of light generated by the laser light source so as to modulate the light beam to create a plurality of lighter and darker pixels within a raster pattern to create the projection.

In some preferred embodiments of the present invention photo microprojector for projecting digital photo albums, the scanner includes a scanner optical assembly having a laser beam reflector selected from the group consisting of two moveable mirrors, one moveable horizontally and the other vertically; a single mirror having both vertical and horizontal rotational axes; a rotating drum with mirrored facets; and a vibrating micro-electro-mechanical system.

In a fourth version of the present invention, the digital photo album projection module includes an image generator with a light source, and a plurality of optical fibers, the image generator being functionally connected to the microprocessor, wherein the microprocessor includes capability to control the image generator to generate projected photo images from a stored digital photo album through the plurality of optical fibers.

The placement of the present invention articulated housing component is dynamic and may be situated on any side of the housing. Furthermore, the articulated housing component is not necessarily located on the same side of the housing as the digital photo album input.

The present invention photo microprojector is adapted to be worn on or about the body of a human. As such, the photo microprojector may be included as part of a piece of jewelry, such as a necklace, a bracelet, a ring, a pin, hair adornment, and the like. Also within the scope of this invention, the photo microprojector, may be part of a headband, incorporated onto one's clothing by clip, or carried in one's pocket.

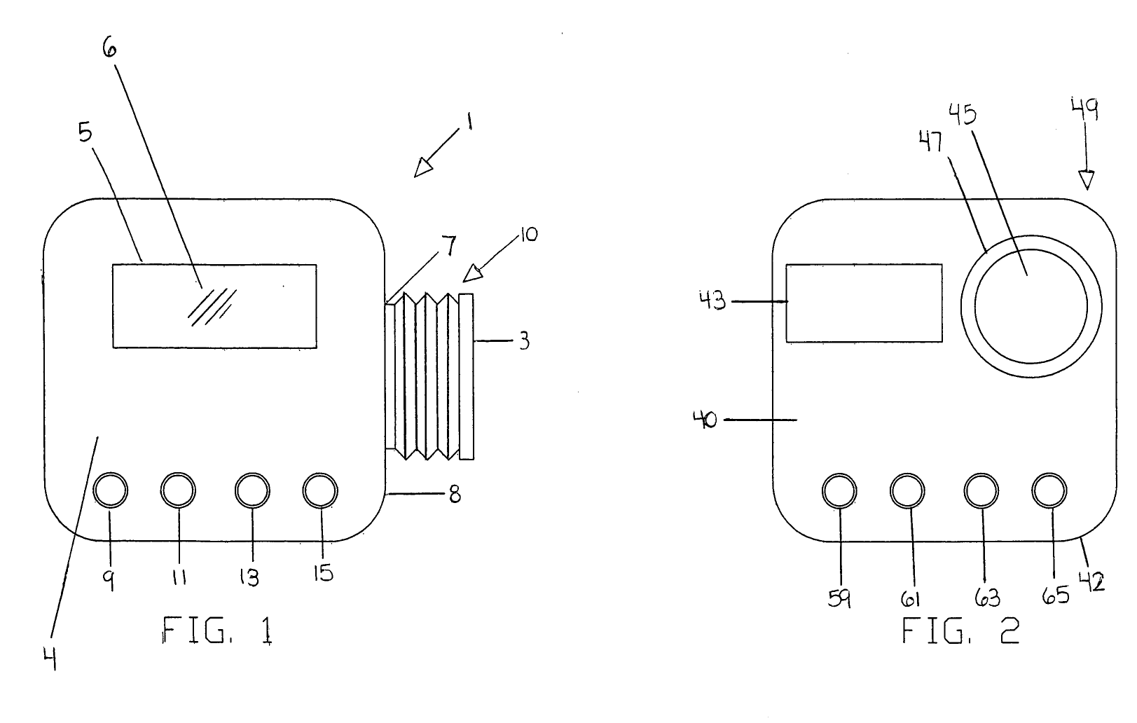

FIG. 1 is a front view of an embodiment of a photo microprojector according to the present invention, illustrating an articulated projection housing component 10 slideably movable from a side 8. The photo microprojector includes a main housing 1 adapted to be worn on or about a human, and having at least a front 4 and the side 8. The front 4 includes a digital photo input means, in this case, digital photo input port 5, and control buttons 9, 11, 13, and 15 for processing between the pressed buttons 9, 11, 13 and 15 and a microprocessor controller (not shown).

The side 8 includes a lens port 3 and a lens port swivel mount 7. The articulated housing component 10 is located within the lens port 3. The lens port swivel mount 7 is hinged and has at least one axis of rotation allowing for at least partial swivel movement away from a perpendicular axis relative to the main housing 1. Furthermore, the lens port swivel mount 7 is adapted for slideable movement at least partially out of and into the main housing 1.

Control buttons 9, 11, 13 and 15 correspond to the functions of on/off, start/stop; forward/reverse; select; and delete; respectively, by pressing the corresponding button. As seen control button 9 activates two functions, which is accomplished by pressing the control button 9 twice within 2 seconds to activate the function. Thus, pressing the control button 9, once, will power on the photo microprojector while immediately pressing the control button 9, a second time, will start sequencing through a digital photo album 6 placed in the digital photo input port 5. To power off the photo microprojector, the control button 9 is pressed twice within two seconds after powering on the device or starting the sequencing through the digital photo album. Pressing control button 9 once having started will stop or pause the sequencing.

The reverse function is adapted to reverse at least a portion of a digital photo album presentation. The select function is adapted to permit a user to choose specific digital photos from a stored digital photo album for presentation, reorganization, or deletion. The delete function is adapted to enable a user to delete one or more digital photos.

FIG. 2 is a front view of another embodiment of a photo microprojector according to the present invention, illustrating an articulated projection housing component slideably movable from the front 40. The photo microprojector includes a main housing 49 having a digital photo input means, in this case, digital photo input port 43, and a lens port 47. The lens port 47 includes the articulated projection housing component, which includes a lens 45. Control buttons 59, 61, 63 and 65 correspond to the functions of on/off, start/stop; forward/reverse; auto cycle; and delete; respectively, by pressing the corresponding button. The auto cycle function is adapted to sequentially present digital photos for a predetermined time in a predetermined sequence.

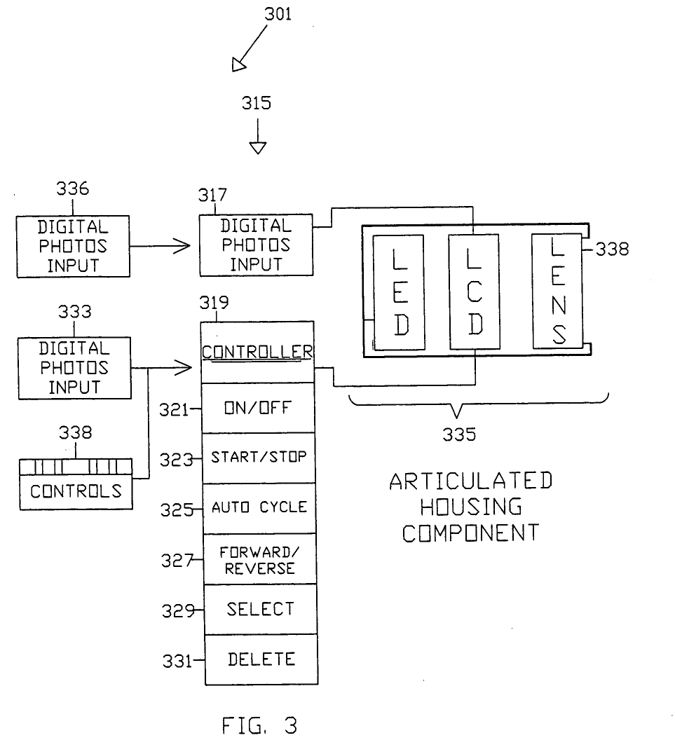

FIG. 3 is a schematic view of a photo microprojector of the present invention, illustrating a light source for projecting photo album images. A main housing 301 has a lens port 341, a digital photo input 335 and a power source 333, button controls 338, and a microprocessor 315. The microprocessor 315 includes: (i) digital photo storage means 317 for storing a plurality of inputted digital photos; (ii) digital photo organization means 317 for selecting and arranging digital photos stored in the microprocessor; (iii) a controller 319 for managing a digital photo album presentation that includes an on/off, start/stop function 323, and a pause function, auto cycle 325, forward/reverse 327, select 329 and delete 331. The microprocessor 315 is connected to the digital photo input means 335. The power source 333 is a battery source, either disposable or rechargeable. In other embodiments, any available power source may be used, e.g., solar cell, fuel cell or the like.

Furthermore, there is an articulated projection housing component 335 within the lens port 341 and including a lens 338, a display screen, in this case, LCD 337 behind the lens 303 and connected to the microprocessor 315. The display screen 337 is adapted to receive photo images from the microprocessor 315. A light source, in this case, LED 339 is also located within the articulated projection housing component 335 and is behind the display screen 337 so as to project photo images from the display screen 337 and magnify them through the lens 338 for projection therefrom. The light source 337 is also connected to the microprocessor 315. The power source 333 is connected to the microprocessor 315. The articulated projection housing component 335 is adapted for slideable movement at least partially out of and into the main housing 301 and is further adapted for at least partial swivel movement away from a perpendicular axis relative to the main housing 301. The articulated housing component 335 has a lens port swivel mount which may be a hinged mount having at least one axis of rotation, a universal joint swivel mount, a bellows mount having popoid features, and a gooseneck swivel mount, as described in FIGS. 1, and 4-6.

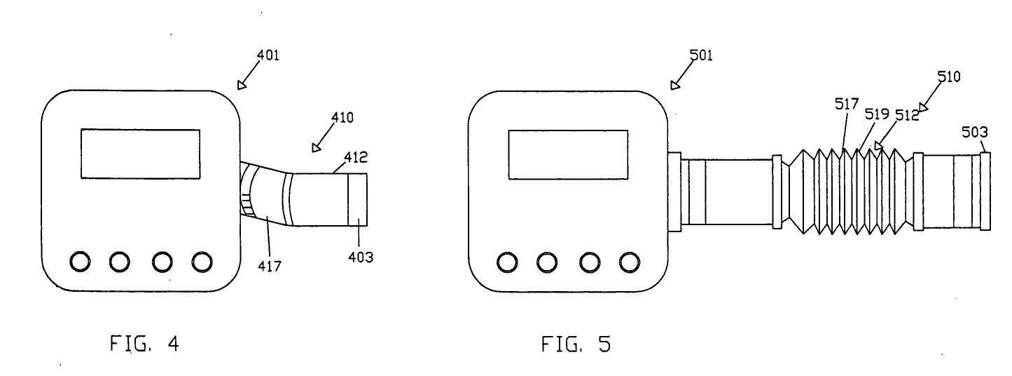

FIG. 4 is a side view of another embodiment of an articulated housing component 410 of the present invention, illustrating a universal joint swivel mount 412. The universal joint swivel mount 412 allows for rotational movement of the portion extending from a joint 417 to a lens 403. Thus, the rotational movement allows for at least partial swivel movement away from a perpendicular axis relative to the main housing 401. Furthermore, the universal joint swivel mount 412 is adapted for slideable movement at least partially out of and into a main housing 401.

FIG. 5 is a side view of another embodiment of an articulated housing component 510 of the present invention, illustrating a bellows mount having popoid features 512. The bellow swivel mount 512 allows for popoid movement, wherein a plurality of corrugations 517, 519 have a configuration, which allows a popoid section between the corrugations 517, 519 to bend and retain its bent orientation. The plurality of corrugations 517, 519 culminate in a lens 503. Thus, the popoid feature allows for at least partial rotational movement away from a perpendicular axis relative to the main housing 501. Furthermore, the bellows mount having popoid features 512 is adapted for slideable movement at least partially out of and into a main housing 501.

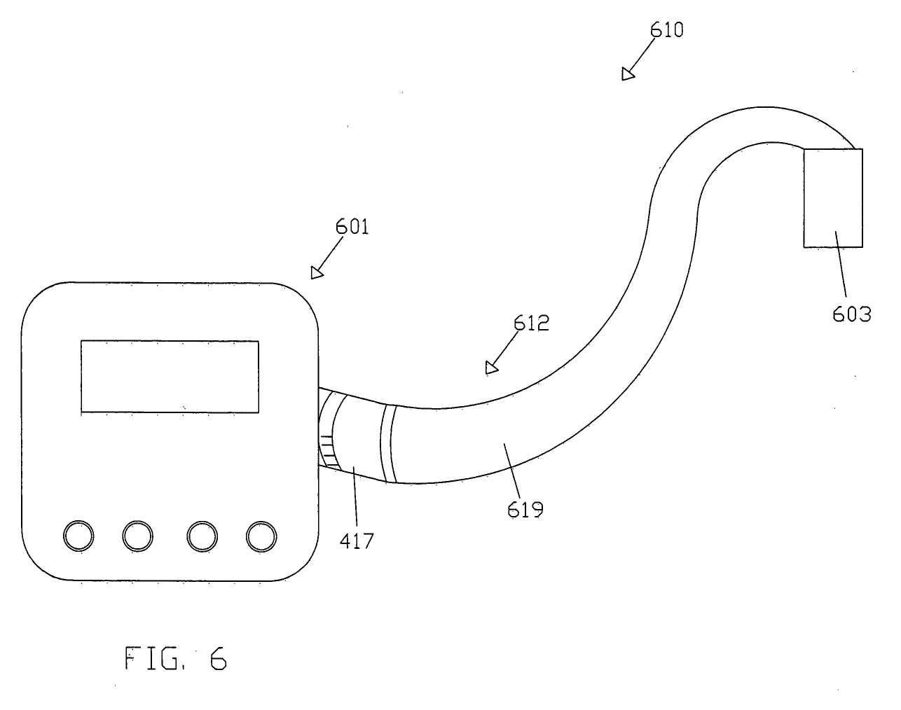

FIG. 6 is a side view of another embodiment of an articulated housing component of the present invention, illustrating a gooseneck swivel mount 612. The gooseneck swivel mount 612 allows for rotational movement of a gooseneck portion 619 extending from a joint 617 to a lens 603. Thus, the rotational movement allows for at least partial swivel movement away from a perpendicular axis relative to the main housing 601. Furthermore, the universal joint swivel mount 612 is adapted for slideable movement at least partially out of and into a main housing 601.

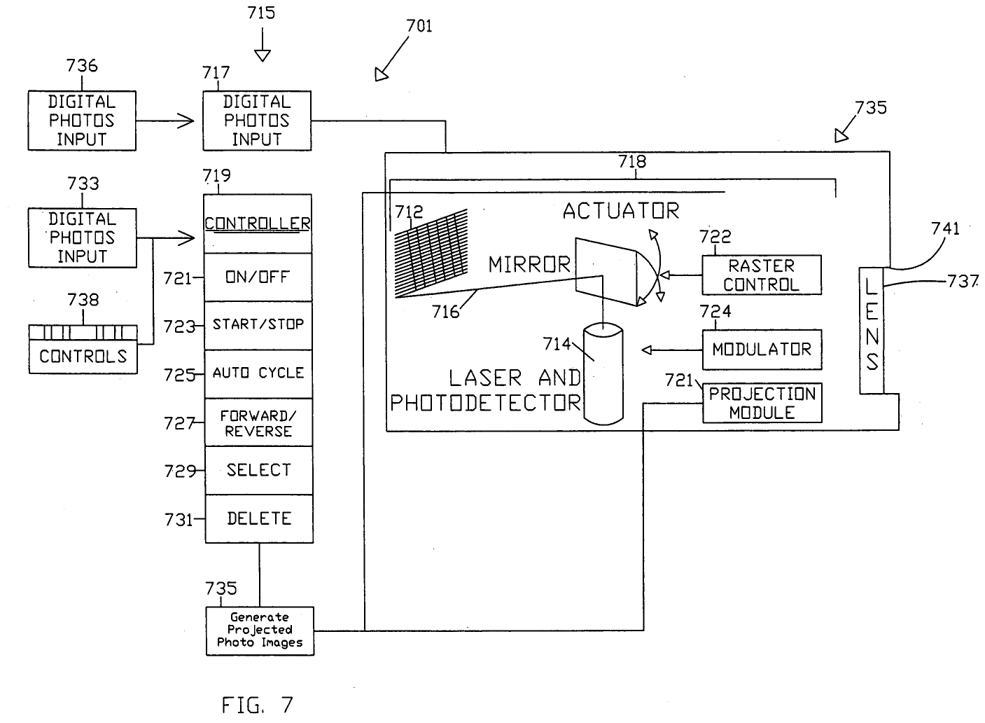

FIG. 7 is a schematic view of a photo microprojector of the present invention, illustrating a laser system for projecting photo album images. FIG. 7 is similar to FIG. 3 in some functions and identical functions are similarly numbered but beginning with “700” instead of “300” and will be incorporated hereinto by reference to the function described by FIG. 3.

An articulated projection housing component 735 is located within a lens port 741 and includes a digital photo album projection module 726, a laser light source 714 and a scanner 718. The articulated projection housing component 735 is adapted for slideable movement at least partially out of and into a main housing 701 and is further adapted for at least partial swivel movement away from a perpendicular axis relative to the main housing 701. The articulated housing component 735 has a lens port swivel mount including: a hinged mount having at least one axis of rotation, a universal joint swivel mount, a bellows mount having popoid features, and a gooseneck swivel mount, as described in FIGS. 1, and 4-6.

The laser light source 714 and the scanner 718 are functionally connected to the microprocessor 715. The microprocessor 715 includes the capability to control the laser and scanning optical assembly to generate projected photo images from a stored digital photo album 717. The scanner 718 includes a scanning optical assembly 720, a raster control 722 and a modulator 724. The scanner 718 has sufficient capability to control vertical and horizontal movement of a laser beam 716 of light generated by the laser light source 714 so as to modulate the light beam 716 to create a plurality of lighter and darker pixels within a raster pattern to create the projection. The scanner 718 includes a scanner optical assembly having a laser beam reflector, in this case, a single mirror 712 with both vertical and horizontal rotational axes.

When the light source 714 emits a beam of light 716, it is steered both vertically and horizontally by the scanner 718 through the lens 737 and projected onto an external surface. The scanned light beam 716 creates a raster by the scanner 718. The laser beam reflector 712 is a mirror hinged on both axes so that the horizontal and vertical scanning functions are combined into one optical element. Other embodiments for a laser beam reflector include two moveable mirrors, one moveable horizontally and the other vertically, a rotating drum with mirrored facets and a vibrating micro-electro-mechanical system. Any other vibrating or rotating optical assembly capable of deflecting light may be employed.

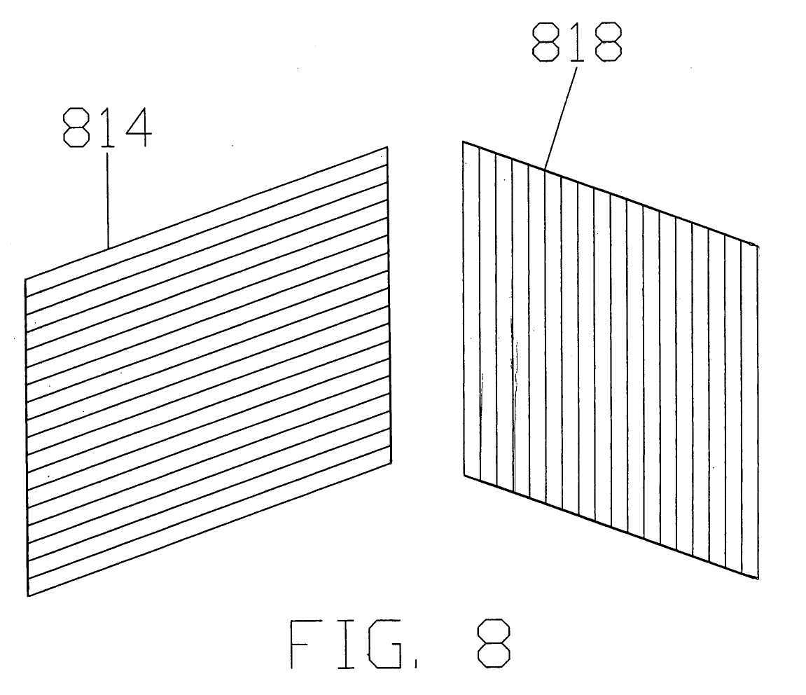

FIG. 8 is a front view of another embodiment of a laser beam reflector for the present invention photo microprojector shown in FIG. 7, illustration two moveable mirrors 814 and 818. A light beam 716 (FIG. 7) is bounced off of the two mirrors moveable mirrors 814 and 818 in sequence, where each mirror scans the light beam 716 in one direction. For example, the first mirror 814 scans the light beam 716 quickly from side to side, while the second mirror 818 sweeps the light beam 716 more slowly from top to bottom, such that each horizontal sweep is performed slightly below the previous sweep, creating a raster of lines.

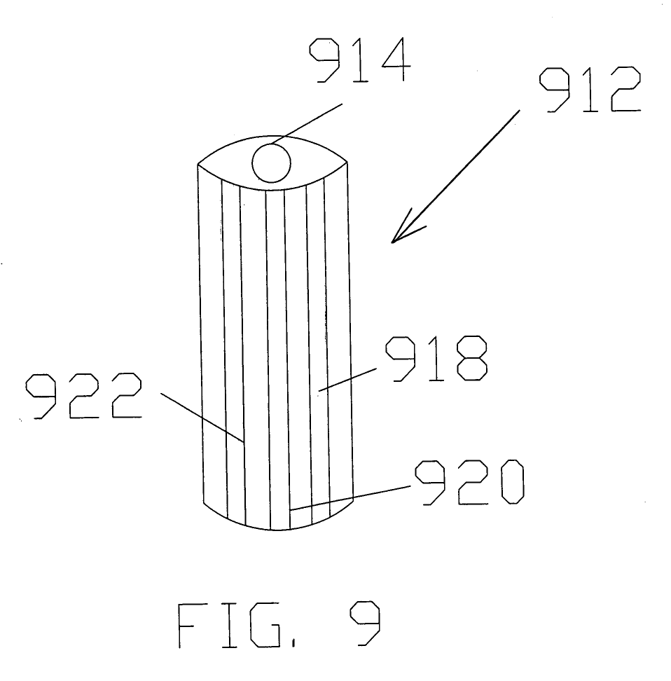

FIG. 9 is a front another embodiment of a laser beam reflector for the present invention photo microprojector shown in FIG. 7, illustrating a rotating drum 912 with a plurality of mirrored facets 918, 920 and 922. The rotating drum 912 rotates around a rotating center 914. The movement of the drum sweeps a light beam 716 (FIG. 7) over the plurality of mirrored facets 918, 920 and 922 so as to create a raster of lines.

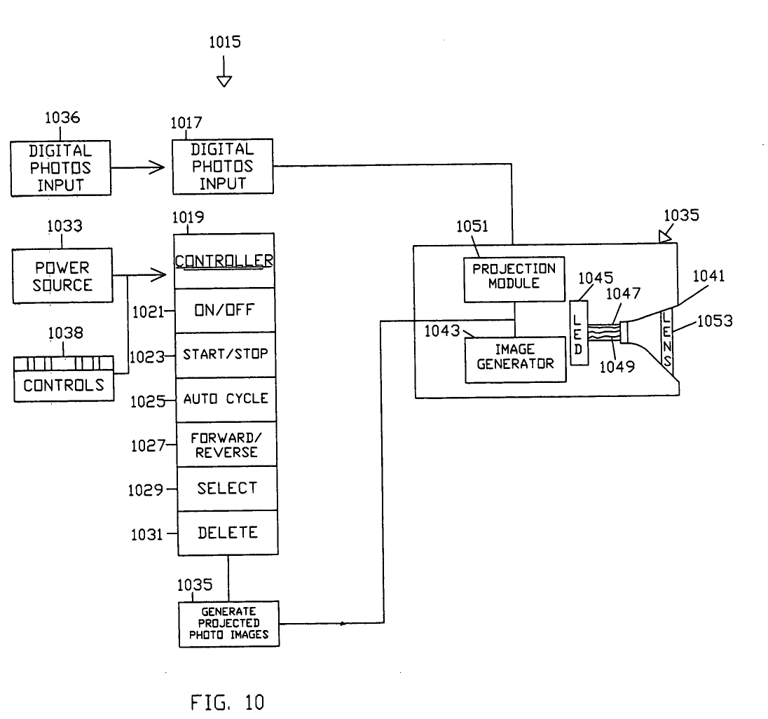

FIG. 10 is a schematic view of a photo microprojector of the present invention, illustrating a fiber optics system for projecting photo album images. FIG. 10 is similar to FIG. 3 in some functions and identical functions are similarly numbered but beginning with “1000” instead of “300” and will be incorporated hereinto by reference to the function described in FIG. 3.

An articulated projection housing component 1035 is located within a lens port 1041 and includes a digital photo album projection module 1051, which includes an image generator 1043 with a light source, in this case, LED 145, and a plurality of optical fibers 1047 and 1049. The articulated projection housing component 1035 is adapted for slideable movement at least partially out of and into a main housing 1001 and is further adapted for at least partial swivel movement away from a perpendicular axis relative to the main housing 1001. The articulated housing component 1035 has a lens port swivel mount including: a hinged mount having at least one axis of rotation, a universal joint swivel mount, a bellows mount having popoid features, and a gooseneck swivel mount, as described in FIGS. 1, and 4-6.

The image generator 1043 is functionally connected to a microprocessor 1015 and includes the capability to control the image generator 1043 to generate projected photo images from a stored digital photo album 1017 through the plurality of optical fibers 1047, 1049 which culminates in being projected through a lens 1053.

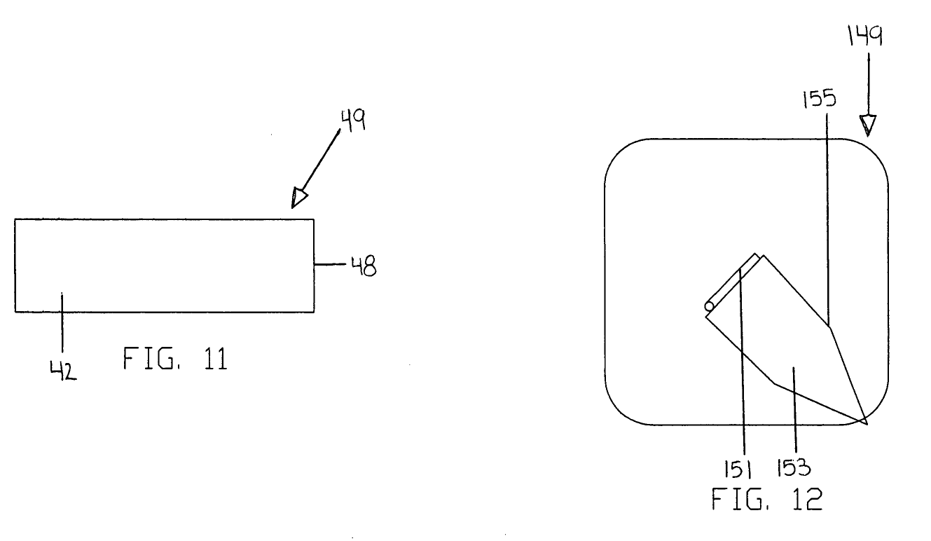

FIG. 11 is a bottom view of a stand component 49 of the present invention, illustrating a flat horizontal surface stand 48. The bottom 42 of the embodiment shown in FIG. 2 is a flat, rectangular, horizontal edge that is capable of resting upon itself. While the photo microprojector is situated standing upon the bottom 42, the side of the device with the lens is directed at the desired target for viewing the photo album images. Thus, for example, when auto cycle mode is initiated, a sequence of photo images is sequentially projected while not having any manual intervention.

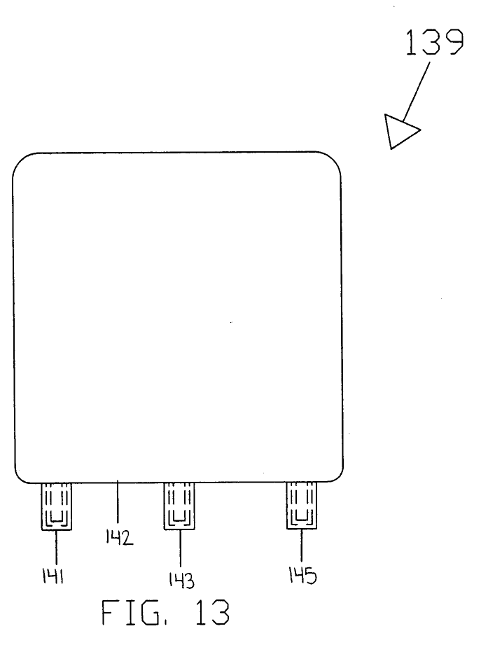

FIG. 12 is a bottom view of a stand component 149 of the present invention, illustrating a hinged pullout bracket stand 155. The hinged pullout bracket 155, which includes a hinge 151 and a bracket 153, is attached to a back 144 of the photo microprojector main housing. While the photo microprojector is supported standing by the hinged pullout bracket 155, the side of the device with the lens is directed at the desired target for viewing the photo album images.

FIG. 13 is a bottom view of a stand component 139 of the present invention, illustrating a telescopic pullout stand with telescoping legs 141, 143, and 145. The telescoping legs 141, 143 and 145, which are attached to a bottom of the photo microprojector main housing for various height adjustment of the stand component 139.

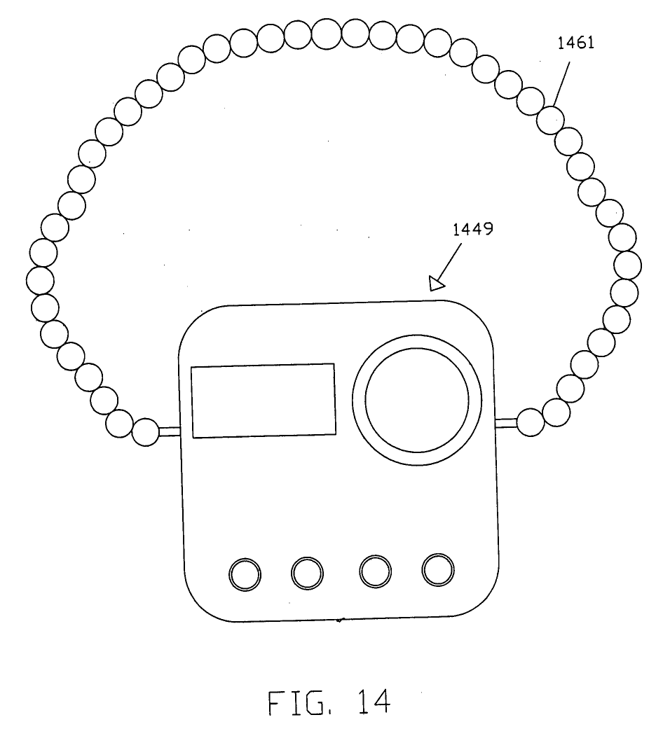

FIG. 14 is a front view of a photo microprojector 1449 as a locket of a necklace 1461. The necklace is attached to the photo microprojector 1449 at two sides. The photo album images may be projected while wearing the necklace 1461 with the photo microprojector locket 1449 around the neck, while removing the necklace 1461 with the photo microprojector locket 1449 attached from the neck, or by removing the photo microprojector locket 1449 from the necklace 1461. A stand component may be employed in order to make the presentation more automatic.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A photo microprojector for projecting a digital photo album, which comprises:
a.) a main housing adapter to be worn on a human, said main housing having a lens port;
b.) a digital photo input means within said main housing and including at least one input port;
c.) a microprocessor in said main housing that includes:
(i) digital photo storage means for storing a plurality of inputted digital photos;
(ii) digital photo organization means for selecting and arranging digital photos stored in said microprocessor;
(iii) a controller for managing a digital photo album presentation that includes a start function, a stop function, and a pause function said microprocessor being connected to said digital photo input means;
d.) a lens located in said lens port;
e.) a display screen located in said main housing and behind said lens and connected to said microprocessor, said display screen being adapted to receive photo images from said microprocessor;
f.) a light source located behind said display screen so as to project photo images from said display screen and magnified through said lens for projection therefrom, said light source being connected to said microprocessor;
g.) a lens port swivel mount located at said lens port and being moveably connected to said main housing so as to have a front position;
h.) a power source connected to said microprocessor.

2. The photo microprojector for projecting a digital photo album of claim 1 wherein said lens port swivel mount is selected from the group consisting of: a hinged mount having at least one axis of rotation; a universal joint swivel mount; a bellows mount having popoid features; and, a gooseneck swivel mount.

3. The photo microprojector for projecting a digital photo album of claim 1 wherein said light source is an LED.

4. The photo microprojector for projecting a digital photo album of claim 1 wherein said display screen is an LCD.

5. The photo microprojector for projecting a digital photo album of claim 4 wherein said display screen is an LCD.

6. The photo microprojector for projecting a digital photo album of claim 1 wherein said controller further includes an auto cycle function adapted to sequentially present digital photos for a predetermined time in a predetermined sequence.

7. The photo microprojector for projecting a digital photo album of claim 1 wherein said controller further includes at least one additional function selected from the group consisting of: a reverse function, adapted to reverse at least a portion of a digital photo album presentation; a select function, adapted to permit a user to choose specific digital photos from a stored digital photo album for presentation, reorganization, or deletion; a delete feature that is adapted to enable a user to delete one or more digital photos.

8. The photo microprojector for projecting a digital photo album of claim 1 wherein said photo microprojector further includes a stand component.

9. The photo microprojector for projecting a digital photo album of claim 8 wherein said stand component is selected from the group consisting of a flat horizontal surface, a hinged pullout bracket, and a telescopic pullout stand.

10. A photo microprojector for projecting a digital photo album, which comprises:
a.) a main housing adapter to be worn on a human, said main housing having a lens port;
b.) a digital photo input means within said main housing and including at least one input port;
c.) a microprocessor in said main housing that includes:
(i) digital photo storage means for storing a plurality of inputted digital photos;
(ii) digital photo organization means for selecting and arranging digital photos stored in said microprocessor;
(iii) a controller for managing a digital photo album presentation that includes a start function, a stop function, and a pause function said microprocessor being connected to said digital photo input means;
d.) an articulated projection housing component in said lens port;
e.) a lens located in said articulated projection housing component;
f.) a display screen located in said articulated projection housing component and behind said lens and connected to said microprocessor, said display screen being adapted to receive photo images from said microprocessor;
g.) a light source located behind said display screen so as to project photo images from said display screen and magnified through said lens for projection therefrom, said light source being connected to said microprocessor; and,
h.) a power source connected to said microprocessor;
wherein said articulated projection housing component is adapted for slideable movement at least partially out of and into said main housing and is further adapted for at least partial swivel movement away from a perpendicular axis relative to said main housing.

11. The photo microprojector for projecting a digital photo album of claim 10 wherein said articulated projection housing component has a swivel mount that is selected from the group consisting of: a hinged mount having at least one axis of rotation; a universal joint swivel mount; a bellows mount having popoid features; and, a gooseneck swivel mount.

12. The photo microprojector for projecting a digital photo album of claim 10 wherein said light source is an LED.

13. The photo microprojector for projecting a digital photo album of claim 10 wherein said display screen is an LCD.

14. The photo microprojector for projecting a digital photo album of claim 12 wherein said display screen is an LCD.

15. The photo microprojector for projecting a digital photo album of claim 10 wherein said controller further includes an auto cycle function adapted to sequentially present digital photos for a predetermined time in a predetermined sequence.

16. The photo microprojector for projecting a digital photo album of claim 10 wherein said controller further includes at least one additional function selected from the group consisting of: a reverse function, adapted to reverse at least a portion of a digital photo album presentation; a select function, adapted to permit a user to choose specific digital photos from a stored digital photo album for presentation, reorganization, or deletion; a delete feature that is adapted to enable a user to delete one or more digital photos.

17. The photo microprojector for projecting a digital photo album of claim 10 wherein said photo microprojector further includes a stand component.

18. The photo microprojector for projecting a digital photo album of claim 17 wherein said stand component is selected from the group consisting of a flat horizontal surface, a hinged pullout bracket, and a telescopic pullout stand.

19. A photo microprojector for projecting a digital photo album, which comprises:
a.) a main housing adapter to be worn on a human, said main housing barring a port;
b.) a digital photo input means within said main housing and including at least one input port;
c.) a microprocessor in said main housing that includes:
(i) digital photo storage means for storing a plurality of inputted digital photos;
(ii) digital photo organization means for selecting and arranging digital photos stored in said microprocessor;
(iii) a controller for managing a digital photo album presentation that includes a start function, a stop function, and a pause function said microprocessor being connected to said digital photo input means;
d.) an articulated projection housing component in said lens port;
e.) a digital photo album projection module located in said articulated projection housing component, said module including a laser light source and a scanner, said laser light source and said scanner being functionally connected to said microprocessor, wherein said microprocessor includes capability to control said laser and scanning optical assembly to generate projected photo images from a stored digital photo album, said scanner including a scanning optical assembly, a raster control and a modulator, said scanner having sufficient capability to control vertical and horizontal movement of a laser beam of light generated by said laser light source so as to modulate the light beam to create a plurality of lighter and darker pixels within a raster pattern to create said projection; and,
f.) a power source connected to said microprocessor;
wherein said articulated projection housing component is adapted for slideable movement at least partially out of and into said main housing and is further adapted for at least partial swivel movement away from a perpendicular axis relative to said main housing.

20. The photo microprojector for projecting a digital photo album of claim 19 wherein said scanner includes a scanner optical assembly having a laser beam reflector selected from the group consisting of two moveable mirrors, one moveable horizontally and the other vertically; a single mirror having both vertical and horizontal rotational axes; a rotating drum with mirrored facets; and a vibrating micro-electro-mechanical system.

21. The photo microprojector for projecting a digital photo album of claim 19 wherein said articulated projection housing component has a swivel mount that is selected from the group consisting of: a hinged mount having at least one axis of rotation; a universal joint swivel mount; a bellows mount having popoid features; and, a gooseneck swivel mount.

22. The photo microprojector for projecting a digital photo album of claim 19 wherein said controller further includes an auto cycle function adapted to sequentially present digital photos for a predetermined time in a predetermined sequence.

23. The photo microprojector for projecting a digital photo album of claim 19 wherein said controller further includes at least one additional function selected from the group consisting of: a reverse function, adapted to reverse at least a portion of a digital photo album presentation; a select function, adapted to permit a user to choose specific digital photos from a stored digital photo album for presentation, reorganization, or deletion; a delete feature that is adapted to enable a user to delete one or more digital photos.

24. The photo microprojector for projecting a digital photo album of claim 19 wherein said photo microprojector further includes a stand component.

25. The photo microprojector for projecting a digital photo album of claim 24 wherein said stand component is selected from the group consisting of a flat horizontal surface, a hinged pullout bracket, and a telescopic pullout stand.

26. A photo microprojector for projecting a digital photo album, which comprises:
a.) a main housing adapter to be worn on a human, said main housing barring a port;
b.) a digital photo input means within said main housing and including at least one input port;
c.) a microprocessor in said main housing that includes:
(i) digital photo storage means for storing a plurality of inputted digital photos;
(ii) digital photo organization means for selecting and arranging digital photos stored in said microprocessor;
(iii) a controller for managing a digital photo album presentation that includes a start function, a stop function, and a pause function said microprocessor being connected to said digital photo input means;
d.) an articulated projection housing component in said lens port;
e.) a digital photo album projection module located in said articulated projection housing component, said module including an image generator with a light source, and a plurality of optical fibers, said image generator being functionally connected to said microprocessor, wherein said microprocessor includes capability to control said image generator to generate projected photo images from a stored digital photo album through said plurality of optical fibers; and,
f.) a power source connected to said microprocessor;
wherein said articulated projection housing component is adapted for slideable movement at least partially out of and into said main housing and is further adapted for at least partial swivel movement away from a perpendicular axis relative to said main housing.

27. The photo microprojector for projecting a digital photo album of claim 26 wherein said articulated projection housing component has a swivel mount that is selected from the group consisting of: a hinged mount having at least one axis of rotation; a universal joint swivel mount; a bellows mount having popoid features; and, a gooseneck swivel mount.

28. The photo microprojector for projecting a digital photo album of claim 26 wherein said light source is an LED.

29. The photo microprojector for projecting a digital photo album of claim 26 wherein said photo microprojector further includes a stand component.

30. The photo microprojector for projecting a digital photo album of claim 29 wherein said stand component is selected from the group consisting of a flat horizontal surface, a hinged pullout bracket, and a telescopic pullout stand.
